(19) United States
(12) Patent Application Publication
(10) Pub. No.: US 2026/0347570 A1
(43) Pub. Date: Nov. 5, 2026

(54) Systems and Methods for Soil Composites

(71) Applicant: San Diego State University (SDSU) Foundation, DBA San Diego State University Research Foundation, San Diego, CA (US)

(72) Inventor: Julio R. Valdes, San Diego, CA (US)

(73) Assignee: San Diego State University (SDSU) Foundation, DBA San Diego State University Research Foundation, San Diego, CA (US)

(21) Appl. No.: 19/488,019

(22) PCT Filed: May 24, 2024
(86) PCT No.: PCT/US2024/031074

§ 371 Date: Nov. 25, 2025

Related U.S. Application Data
(60) Provisional application No. 63/504,603, filed on May 26, 2023.

(51) Int. Cl. C08K 3/34; B33Y 70/10; C08J 3/28

(52) U.S. Cl. CPC C08K 3/346; B33Y 70/10; C08J 3/28

(57) ABSTRACT

Systems and methods for making soil and polymer composites are described. Various types of soil particles can be mixed with polymers such as (but not limited to) thermoplastics and thermosets to form composites. Composites can be created by mixing and/or heating a mixture of soil with polymer particles. Heat can be applied such as (but not limited to) externally with a convection oven and/or radiant heat, and/or internally with a microwave source such as (but not limited to) a microwave oven. The soil composites can be formed by heating of 3D printed and other formed bodies after printing or extrusion.

### CROSS-REFERENCE TO RELATED APPLICATIONS

The current application claims the benefit of and priority to U.S. Provisional Patent Application No. 63/504,603 entitled “Systems and Methods for Soil Composites” filed May 26, 2023. The disclosure of U.S. Provisional Patent Application No. 63/504,603 is hereby incorporated by reference in its entirety for all purposes.

### FIELD OF THE INVENTION

The present disclosure is directed to soil composites; and more particularly to soil composites formed with soil and polymer species and via microwave heating and heating of 3D printed and other formed bodies after printing or extrusion.

### BACKGROUND

Various agents such as Portland cement, lime, gypsum, calcium carbonate, biopolymers, and geopolymers can be used to produce cemented aggregates. Liquid polymer and biopolymer soil mixtures have been utilized to improve the physical properties or characteristics of soils for various applications such as geotechnical engineering projects, construction activities, agricultural uses (water retention), road dust control, soil strengthening or stabilization, and erosion control. Integration of polymers into soil can improve the strength and stiffness of the soil and can alter the fluid conduction properties of the soil.

### BRIEF SUMMARY

Embodiments of the present disclosure are directed to soil composites; and more particularly to soil composites with polymer species.

Some embodiments include a method for fabricating soil composite, comprising heating a mixture of materials using a microwave source, wherein the mixture of materials comprises a plurality of soil particles and a plurality of polymer particles.

In some embodiments, the plurality of soil particles comprises at least one material selected from the group consisting of: sand, slit, clay, rammed earth, gravel rock, desert sand, beach sand, white sand, river sand, manufactured sand, and granular ceramic.

In some embodiments, the plurality of soil particles comprises at least one microwave susceptor selected from the group consisting of: a natural conductive grain in sand, a ferric material, iron oxide, Fe₂O₃, carbon black, charcoal, graphite, silicon carbide, magnetite, and Fe₃O₄.

In some embodiments, the plurality of polymer particles comprises a thermoplastic polymer or a thermoset polymer.

Some embodiments further comprise molding the mixture before heating.

In some embodiments, the molding is achieved via using a mold or 3D printing.

In some embodiments, the mold has a shape selected from the group consisting of: a cylinder, a tube, a sphere, a hemi-sphere, an ellipse, a polygon, a cuboid, a cube, and a combination thereof.

In some embodiments, the microwave source creates a heating temperature less than or equal to 350 °C.

Some embodiments include a method for fabricating soil composite, comprising molding a mixture material, wherein the mixture material comprises a plurality of soil particles and a plurality of polymer particles; wherein greater than 50% (v/v %) of the plurality of soil particles has an average diameter of less than or equal to 100 microns, and less than 50% (v/v %) of the plurality of soil particles has an average diameter of greater 100 microns.

Some embodiments further comprise heating the molded mixture material using a heat source selected from the group consisting of: a microwave source, an external heating source, and a convention oven.

In some embodiments, the plurality of soil particles further comprises at least one material selected from the group consisting of: sand, slit, clay, rammed earth, gravel rock, desert sand, beach sand, white sand, river sand, manufactured sand, and granular ceramic.

In some embodiments, the plurality of soil particles further comprises at least one microwave susceptor selected from the group consisting of: a natural conductive grain in sand, a ferric material, iron oxide, Fe₂O₃, carbon black, charcoal, graphite, silicon carbide, magnetite, and Fe₃O₄.

In some embodiments, the plurality of polymer particles comprises a thermoplastic polymer or a thermoset polymer.

In some embodiments, the microwave source creates a heating temperature less than or equal to 350 °C.

In some embodiments, the molding is formed via a process of using a mold or 3D printing.

In some embodiments, the mold has a shape selected from the group consisting of: a cylinder, a tube, a sphere, a hemi-sphere, an ellipse, a polygon, a cuboid, a cube, and a combination thereof.

Some embodiments include a soil composite, comprising a plurality of soil particles and a plurality of polymer particles fused together using a microwave source, wherein the microwave source melts the plurality of polymer particles and binds the plurality of soil particles together.

In some embodiments, the plurality of soil particles comprises at least one material selected from the group consisting of: sand, slit, clay, rammed earth, gravel rock, desert sand, beach sand, white sand, river sand, manufactured sand, and granular ceramic.

In some embodiments, the plurality of soil particles comprises at least one microwave susceptor selected from the group consisting of: a natural conductive grain in sand, a ferric material, iron oxide, Fe₂O₃, carbon black, charcoal, graphite, silicon carbide, magnetite, and Fe₃O₄.

In some embodiments, the plurality of polymer particles comprises a thermoplastic polymer or a thermoset polymer.

In some embodiments, the microwave source creates a heating temperature less than or equal to 350 °C.

Further features and advantages, as well as the structure and operation of various embodiments, are described in detail below with reference to the accompanying drawings. It is noted that the specific embodiments described herein are not intended to be limiting. Such embodiments are presented herein for illustrative purposes only. Additional embodiments will be apparent to persons skilled in the relevant art based on the teachings contained herein.

### DESCRIPTION OF FIGURES

The description will be more fully understood with reference to the following figures, which are presented as exemplary embodiments of the invention and should not be construed as a complete recitation of the scope of the invention, wherein:

FIG. 1 illustrates SEM images of polymer particles, sand grains, and mineral fines in accordance with an embodiment.

FIGS. 2A and 2B illustrate an FTIR spectrum and a thermogram of the polymer respectively in accordance with an embodiment.

FIG. 3 illustrates soil sample temperatures in accordance with an embodiment.

FIGS. 4A and 4B illustrate molten polymer sites in accordance with an embodiment.

FIGS. 5A and 5B illustrate tensile strengths of specimens in accordance with an embodiment.

FIG. 6 illustrates particle size distributions of the polymer and kaolinite particles in accordance with an embodiment.

FIG. 7 illustrates a stress-time curve in accordance with an embodiment.

FIG. 8 illustrates pictures of the bricks in accordance with an embodiment.

FIG. 9A illustrates a schematic of brick fabrication process and testing in accordance with an embodiment.

FIGS. 9B and 9C illustrate p-wave measurement setups in accordance with an embodiment.

FIG. 10 illustrates p-wave testing signal pairs in accordance with an embodiment.

FIGS. 11A through 11F illustrate optical microscope images of selected specimens in accordance with an embodiment.

FIG. 12 illustrates a summary of the stress relaxation behavior associated with compression results in accordance with an embodiment.

FIG. 13 illustrates heat-induced volumetric strain transition from green body to brick in accordance with an embodiment.

FIG. 14 illustrates brick water absorption in accordance with an embodiment.

FIG. 15 illustrates the p-wave velocities and moduli of green bodies in accordance with an embodiment.

FIG. 16 illustrates the p-wave velocities and moduli of un-wetted and wetted bricks in accordance with an embodiment.

FIG. 17 illustrates tensile strength vs. polymer content for un-wetted and wetted bricks in accordance with an embodiment.

FIG. 18 illustrates a power law relationship between the tensile strength and porosity-binder ratio for bricks in accordance with an embodiment.

FIG. 19 illustrates tensile strengths of un-foamed and foamed 3D printed clay-polymer composites in accordance with an embodiment.

### DETAILED SUMMARY

Provided herein are system, apparatus, device, and/or method embodiments, and/or combinations and sub-combinations thereof for soil or for other granular material-based composites. Systems and methods for making soil and polymer composites are described. Various types of soil particles can be mixed with polymers such as (but not limited to) thermoplastics and thermosets to form composites. Composites can be created by mixing and/or heating a mixture of soil with thermoplastic or thermoset particles. The heat melts the polymer particles. The molten polymer spreads throughout the soil. Upon cooling, the polymer hardens and bonds the soil grains together. The molten polymer acts like a glue that binds the soil together into a composite. Heat can be applied such as (but not limited to) externally with a convection oven and/or radiant heat, and/or internally with a microwave source such as (but not limited to) a microwave oven.

In many embodiments, soils can include different types of particles, such as sand, slit, clay, rammed earth, gravel, rock, desert sand, beach sand, white sand, river sand, manufactured sand, and combinations thereof. Soils can comprise silica (silicon dioxide, SiO₂), quartz, alumina, iron oxide, calcium oxide, calcium carbonate, other minerals, other ceramics, and combinations thereof. Susceptors such as iron oxides (e.g., Fe₃O₄) can be naturally present in soils or can be added. A susceptor is a material that can absorb electromagnetic energy, such as microwave energy, and convert it to heat.

Certain embodiments implement polymer particles with an average diameter less than or equal to about 100 microns to prevent segregation. The polymer content in the composites can have a gravimetric percentage range from about 2% to about 10%; or from about 2% to about 5%; or from about 10% to about 50%; or less than about 10%; or greater than about 50%.

Different contents of mineral fines, polymer, and susceptors may affect the heating efficiency and the mechanical properties of the resulting composites. Increased heat retention can be achieved by increasing the fines content and the susceptor content (the latter in the case of microwave heating). Composites can be formed with or without the use of water.

Mixtures that contain a predominance of particles with an average diameter smaller than about 100 microns such as (but not limited to) clay, may be extrudable as free-standing bodies after dry pressing. In several embodiments, clay-polymer mixtures and clay-sand-polymer mixtures can be formed as as-formed composites without the need for heating. These as-formed composites have improved mechanical properties, when compared with those of any of the individual starting materials. Heating can be further applied to the as-formed composites to melt the polymer and thus bind the mixture together. Heating does not alter the geometrical properties of the as-formed composites. Heating can further improve the mechanical properties of composites. Mixtures and/or as-formed composites that contain clay may also be held in molds during heating.

Mixtures that contain a predominance of particles with an average diameter larger than about 100 microns such as (but not limited to) sand, may not be extrudable as free-standing bodies after dry pressing. Therefore, such mixtures may need to be heated while contained in a mold to form bonded composites. Molds can have the shape of (but not limited to) a cylinder, a tube, a sphere, a hemi-sphere, an ellipse, a polygon, a cuboid, a cube, and can be made of materials such as (but not limited to) glass and/or ceramic. Metal molds can also be used; in the case of microwaves, such mold may serve as a waveguide.

Convection and conduction heat transfer processes belong to the category of external heating, where heat is conducted from the body's surface to its core. During external heating processes, the body's heating is primarily controlled by its thermal conductivity. Soil has relatively low thermal conductivity such that external heating can have limitations when used for making soil composites. One limitation of external heating can be pronounced thermal gradients and uneven heating (and bonding). Another limitation can be a long duration to efficiently heat (and bond) a body of considerable size. Soil composites can be large, such that external heating may not be practical for heating large bodies.

Microwave heating belongs to the category of internal heating, where heat is generated within the radiated body as it transforms the absorbed electromagnetic energy into heat. Internal heating has advantages when compared to external heating. Internal heating enables the polymer-bonding of larger masses for the same amount of heating time, when compared to external heating. Microwave susceptors, such as iron oxides present in natural soils, produce heat as they absorb microwaves, promoting uniform heating throughout the soil mass. When used for creating composites of soil and thermoplastic or thermoset polymers, microwaves can produce quick and homogeneous bonding of soil particles of various sizes.

Many plastics and/or thermoplastics and/or thermosets are not effective microwave absorbers and therefore do not melt or soften readily under microwave exposure. Many embodiments use microwaves to produce composites comprising soil mixed with thermoplastic or thermoset particles. Several embodiments incorporate susceptors to enhance microwave absorption. Soils that contain susceptors can heat up sufficiently to melt plastic particles embedded within in accordance with many embodiments. Examples of susceptors in the composites include (but are not limited to) natural conductive grains in sand, ferric materials, iron oxide, Fe₂O₃, carbon black, charcoal, graphite, silicon carbide, and magnetite (Fe₃O₄).

Soil can contain a variety of amounts of microwave-absorbent grains (susceptors) relative to microwave non-absorbent grains. For example, the soil can contain a small content of (less than or equal to about 10%) of microwave absorbent grains and a large content of microwave non-absorbent grains. The non-absorbent grains allow the microwaves to penetrate longer distances, whereas the susceptors act as internal heating elements that enable internal heating of the soil mass and the melting of the added polymer. The presence of susceptors contributes to heating the mixture homogeneously and sufficiently to melt the added polymer particles, such that large composite objects can be produced quickly and efficiently. Furthermore, a fractured body can be reannealed (healed) via re-exposure to microwaves. The microwave heating protocol can be optimized for different soil compositions.

The susceptors content in the composites can have a gravimetric percentage range less than or equal to about 10%; or from about 10% to about 20%; or from about 20% to about 30%; or from about 30% to about 40%; or from about 40% to about 50%.

Microwaves with frequency of about 2.45 GHz can penetrate into dry soil a distance greater than or equal to about 0.5 m if 10% susceptors are present, or greater than or equal to about 1 m when susceptors not present. Water in the pores of wet soil can act as the primary microwave absorber (for 2.45 GHz waves), thereby reducing the penetration depth. Microwaves can penetrate dry soils a longer distance when compared to wet soils.

Heating with microwaves enables the formation of large-scale composites and/or objects. The produced composites with microwaves can have various sizes. The composites in accordance with many embodiments can have a total weight from about 1 gram to about 1000 grams; or from about 1 gram to about 500 grams; or greater than or equal to about 1000 grams.

The microwave heating time can vary from about 1 minute to about 5 minutes; or from about 1 minute to about 4 minutes; or from about 1 minute to about 3 minutes; or from about 1 minute to about 2 minutes; or less than about 1 minute; or greater than about 5 minutes. The efficiency of the microwave heating protocol depends on a variety of parameters such as (but not limited to) microwave field strength, microwave frequency, size of the composite, composition of the composite, types of soil, types of susceptors, types of polymers, and/or the foreseen application of the composite.

Heating too quickly can cause fractures and bulging in the composites. The microwave field strength (E_{f}) needs to be controlled to prevent excessively fast heating, and to allow sufficient time for the molten polymer to coalesce and flow inside the soil's pores. Examples of microwave field strength Er can be less than or equal to about 1 kV/m; or greater than about 1 kV/m. The field strength Er can be adjusted as part of the protocol and based on the composition of the mixture.

Some embodiments implement a mixture of clay, sand, and polymer with a volume ratio of about 30%, about 30%, and about 40%, respectively. The sand can include about 10% susceptor grains. The clay fraction in the mixture enables extrusion of free-standing bodies that can then be heated with microwaves to form composites. The microwave field strength Er can be about 0.75 kV/m. However, the microwave protocols (field strength and duration) depend on the composition of the mixture and on the size of the compressed body. The thermally bonded composites can have a tensile strength larger than that of fired clay bricks (FCBs) and absorb less water than FCBs. These thermally bonded composites can be produced without water, with less energy than, and faster than FCBs. Production of such composites can generate less than about ¼ of the greenhouse gases produced in the manufacture of FCBs.

### Sand-Polymer Composites

The use of mineral aggregates to produce solid materials marks many historical advancements in civil engineering. The ongoing development of ways to create bonded materials has led to explorations into the use of various agents such as Portland cement, lime, gypsum, calcium carbonate, biopolymers, and geopolymers to produce cement aggregates.

Many embodiments provide soil-polymer composites. In the soil-polymer composites, the added polymer particles melt when the mixture is heated, rendering a bonded composite upon cooling. Such composite is a granular packing with grains that are bonded by polymer bridges. This type of composite differs from the dispersion-strengthened variety, where the non-polymeric particles comprise a discontinuous phase embedded in a polymer matrix. Prior work on polymer-bonded sands relied on external heating (e.g., a convection oven): the specimen surfaces are first heated, and the heat permeates the specimen, i.e., towards the core, by conduction. Heating is primarily controlled by the thermal conductivity of the material, which is relatively low for common soils and aggregates. This gives rise to a poor heat transfer that can result in the need for relatively long heating protocols and in pronounced thermal gradients and heterogeneous polymeric bonding, particularly if the target mass is of considerable size. Many embodiments overcome this limitation by implementing microwave heating. Microwaves can produce internal heating, therefore less heterogeneous thermal profiles, provided that the power penetration depth extends beyond the dimensions of the target mass. In several embodiments, the use of microwave heating can overcome the limitations associated with conventional external heating of low thermal conductivity materials to produce polymer-bonded sand specimens in the laboratory.

Bonding of soil grains can be achieved by melting added polymer particles mixed with dry soil. Salient challenges associated with conventional external heating via boundary conduction include long treatment durations and inhomogeneous bonding. In many embodiments, microwaves can be used to enable the heat-induced bonding of sand-silt mixtures that contain added thermoplastic or thermoset polymer particles. The use of microwaves can induce quick internal heating. In certain embodiments, internal heating produces homogeneous bonding much quicker than external heating (by a factor of 20) on sand-silt specimens that contain a 10% fraction of natural microwave susceptor grains, particularly when the target soil mass is relatively large. The temperatures attained from microwaves are sufficient to melt the polymer particles, thus bonding the mineral grains upon cooling. The tensile strength (qₜ) of the specimens bonded via microwave heating is inversely proportional to their fines content (FC), although the temperatures sustained by soils increase with increasing fines content. Bonded specimens subject to a wetting-drying cycle exhibit lower tensile strengths than their un-wetted counterparts. Specimens subject to re-exposure to microwaves after a wetting-drying cycle exhibit tensile strengths of at least 85% that of analogous un-wetted specimens. The power penetration depth for 2.45 GHz microwaves is calculated to be 0.5 m<Sₚ<0.8 m for dry soils. Therefore, potential applications include large brick manufacturing, rapid repair of temporary runways, and treatment of polymer particle-laden rammed earth walls.

In many embodiments, microwave heating can bond sand-silt mixtures via melting of added polymer particles. Upon cooling, the melted polymer particles can bond to the mineral grains. The use of microwave heating can overcome the limitations associated with conventional external heating and increase the target soil mass's heating rate while promoting homogenous heating of such mass. In several embodiments, the internal heating via microwaves, particularly for relatively large soil specimens, is readily measurable provided that the soil has a favorable content of microwave susceptor grains (~10% for the soils). In particular, the time required to heat a relatively large soil mass via microwaves is about 20 times shorter than that required to heat an equal soil mass via conventional external heating.

The soil's fines content can play a compromising role on microwave heating and the resulting polymer-bonding. On one hand, the attained temperature is proportional to fines content because the radiation heat transfer is proportional to the surface area. On the other hand, the tensile strength of the bonded composite is inversely proportional to the fines content because the amount of polymer needed to produce bonded grain interconnectivity rises as the mineral surface area increases.

In several embodiments, the tensile strengths of bonded specimens subject to wetting are lower than those of un-wetted bonded specimens. This result limits the applications to the ones where the bonded material is coated with waterproofing or kept dry throughout its working life. However, other microwave-cured constituents (e.g., moisture-resilient polymer matrix) could be leveraged based on specific application requirements. Nevertheless, the tensile strengths of wetted specimens can be largely regained upon completion of a subsequent dose of microwave heating. This is attributed to the re-annealing of polymer chains rendered by melting. The ability to heal the material via microwave exposure thus emerges as an attribute of microwave heating.

In some embodiments, the microwave power penetration depth in dry soils is around 0.5 m. The implementation of microwave heating to manufacture large bricks and enhanced rammed earth systems can be potential applications in accordance with some embodiments.

Many embodiments implement microwave heating to form composites by melting the polymer particles and bonding the sand particles with melted polymer. Microwaves produce internal heating and therefore less heterogeneous thermal profiles, provided that the power penetration depth extends beyond the dimensions of the specimen. The bonding material can be a polymer powder, such as 016/00030 by Tiger Drylac for surface coating applications, made of angular particles with d_{poly}<80 μm. It has a specific gravity Gₛ of about 1.2, a tensile elastic modulus of about 460 MPa, and a tensile strength of about 17 MPa at a strain of about 5% (attained via the tensile testing of precast dog-bone specimens). It softens, i.e., no longer behaves as a powder, at about 95 °C. The polymer's spectral features were resolved using a Fourier Transform InfraRed (FTIR) spectrometer over the spectral region of 400 cm⁻¹ to 4000 cm⁻¹. The spectrum is characteristic of polyester. The polymer's thermogram, obtained with a thermogravimetric analyzer, indicates that the polymer is thermally stable below about 285 °C.

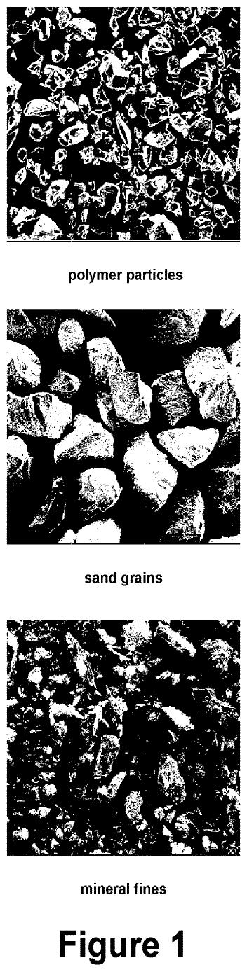

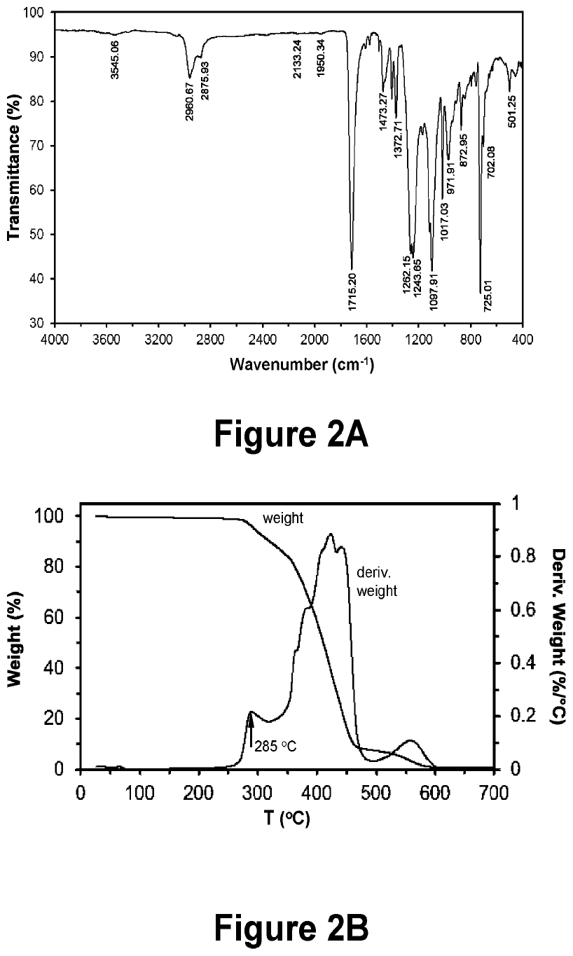

FIG. 1 illustrates SEM images of polymer particles, sand grains, and mineral fines in accordance with an embodiment. FIGS. 2A and 2B illustrate an FTIR spectrum and a thermogram of the polymer respectively in accordance with an embodiment.

Several embodiments provide the effect of soil's composition on microwave-mediated polymeric bonding. A siliceous medium brown sand with Gₛ=2.65 (multi-purpose sand graded ASTM C33) can be used. As shown in FIG. 1, clean sand and silt fines can be scalped. The soil can be probed with a magnet to identify the presence of magnetic grains that would act as embedded heating elements, i.e., microwave susceptors. A magnetic grain content of the soil is about 10%. The minority of the magnetic grains are visibly identified as magnetic or conductive as well, being black, gray, red and/or brown. These grains, as ferric susceptors, can readily convert microwave energy into heat via pronounced magnetic and conduction losses. A soil with about 10% susceptor grains is ideal for microwave-mediated bonding, by having sufficient absorptive material to enable heating, yet not too high as to render the material practically impenetrable by microwaves.

Target soils can be prepared by sieving the selected soil into (i) 40-50 sand with diameters greater than about 0.3 mm and less than or equal to about 0.425 mm, and (ii) silt fines with diameters less than about 75 μm, and then combining such components into sand-silt mixtures with predetermined FC. For dry soil composed of angular sand and fines, the fines are mobile when FC<5%, begin to exhibit interconnectivity when FC≈20%, and predominate when FC>40%. Therefore, the four target soils are prepared based on the regimes identified above, to cover the compositional range of potential candidate sands: FC=0, 5, 20, and 50%.

The microwave heating response of each target soil is characterized as follows. First, 15 grams of soil are tamped at room temperature inside a microwave-transparent quartz tube with a diameter=2.5 cm and underlain by a quartz plate. The specimen (inside the tube and on the plate) is then exposed to 2.45 GHz microwaves for a predetermined duration in a microwave oven that sustains an average electric field strength of E_{f}=1.2 kV/m, calculated based on the temperature increase by water in a beaker placed inside the oven. Immediately after microwave exposure, the soil is released onto the plate by manually lifting and the tube. This process is done quickly while the temperature of the soil is measured with a FLUKE Ti25 thermal imager. The temperature attained for a given microwave exposure duration is confirmed to increase with increasing fines content. This is consistent with the radiative heat transfer process associated with microwave heating:

Q=σₕεₘ(T⁴−T₀⁴)A

where Q is the radiation heat transfer rate, σₕ is the Stefan-Boltzmann constant (5.67×10⁻⁸ W/m²K⁴), εₘ is the emissivity, T is the sample temperature, and T₀ is the surrounding temperature. Increasing the fines content results in higher temperatures because smaller particles render an increase in the surface area, A.

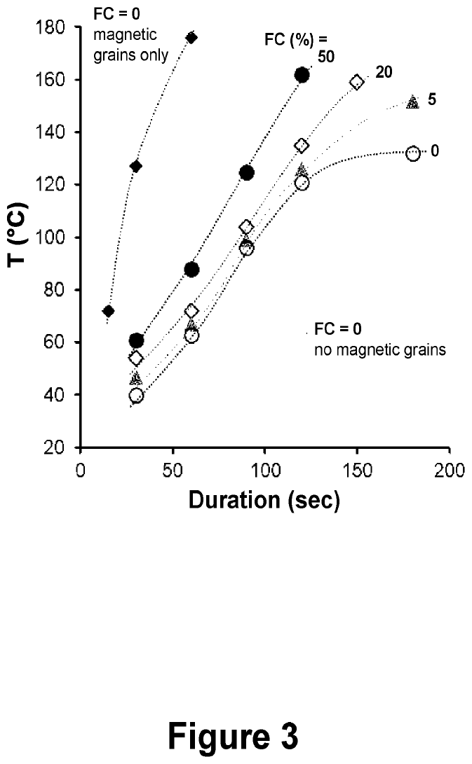

FIG. 3 illustrates soil sample temperatures in accordance with an embodiment. Temperatures shown in FIG. 3 are the temperatures reached by soil samples placed inside a 2.45 GHz microwave oven (E_{f}=1.2 kV/m) for the durations from 0 second to about 200 seconds. Microwave heating tests were also conducted on samples of magnetic grains extracted from the FC=0 soil, as well as on a sample of FC=0 soil from which magnetic grains were removed. The results confirm that the magnetic grains are microwave susceptors, given that (i) the rate of microwave heating for magnetic grain samples is substantially higher than that of the target soils, and (ii) the temperature of the sample with no magnetic grains fell well short of those reached by the analogous F=0 target soil. The selected soil was coincidentally found to be ideal for microwave-mediated bonding, as it had sufficient absorptive material to enable internal heating, yet not too high as to render the material practically impenetrable by microwaves.

Each polymer bonded specimen can be prepared as follows. First, a predetermined target soil and polymer particles are dry mixed to achieve a gravimetric polymer content, PC=mₚ/m_{T}=2, 5, or 10%, where mₚ is the mass of polymer particles and m_{T} is the total mass. Second, the material is first tamped inside a quartz tube (diameter=2.5 cm), lined with parchment paper to achieve a cylindrical specimen with a height of approximately 60% of the tube's diameter. Specimens of the same family (i.e., FC and PC) are compacted to a consistently achievable density attained via manual tamping, which is maintained to ensure repeatability in specimen preparation. In turn, specimen preparation can be made more consistent using small (vs. large) specimens. Third, the compacted mixture is placed inside a microwave oven (for example, as described above) for two minutes. The treatment duration is selected based on the polymer's softening temperature, the specimen mass and size, and the temperatures attained by target soils. Lastly, the specimen is allowed to cool at room temperature, after which it is extruded from the quartz tube. In this case, the quartz tube is used as mold because the soil does not contain sufficient fines (silt or clay) to enable compressing and extruding a free-standing body.

The measurement of the tensile strength (qₜ) is chosen to isolate the bonding quality, from which the tensile resistance of the bonded material is derived. Each specimen is subject to tensile strength testing: (1) immediately after microwave treatment, (2) after four weeks of submersion in de-ionized water followed by air drying, or (3) after four weeks of submersion in de-ionized water followed by air-drying and an additional two-minute-long microwave dose. The infiltration and drying protocol are imposed on the specimens not to test the material's response to wetting-drying cycles per se (for example, according to ASTM D559) but to subject the specimens to a treatment that would likely degrade their integrity, yet not to the point of complete de-structuration. In turn, the degree to which a resulting strength reduction could be mitigated by microwave reheating would be potentially measurable. The tensile strength can be measured via disc tension (ASTM D3967-16), where each specimen is loaded diametrically to failure by fracturing across its equator. Various tests can be conducted in duplicate to evaluate repeatability.

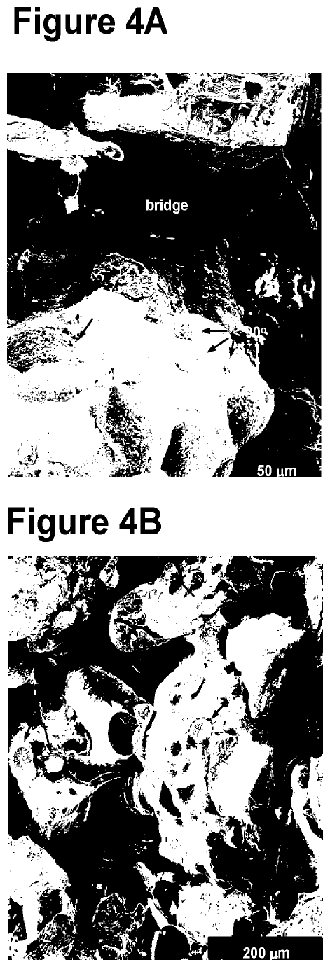

FIGS. 4A and 4B illustrate molten polymer sites in accordance with an embodiment. FIG. 4A shows the mineral surface is wet to the polymer (sessile droplets with contact angle <90°). Proximal particles coalesce upon melting, in some cases forming polymer bridges across mineral surfaces as shown in FIG. 4B. The predominant failure mechanism is polymer bridge rupture. SEM images confirm microwave-mediated bonding via the visible wettability of the mineral to the molten polymer (i.e., contact angle <90°), with polymer bridges spanning sites where no contact existed (FIG. 4A). The predominant grain-scale failure mechanism observed is the rupture of such bridges (FIG. 4B). Proximal polymer particles coalesce upon melting, in some cases forming polymer bridges across mineral surfaces. The predominant failure mechanism is polymer bridge rupture.

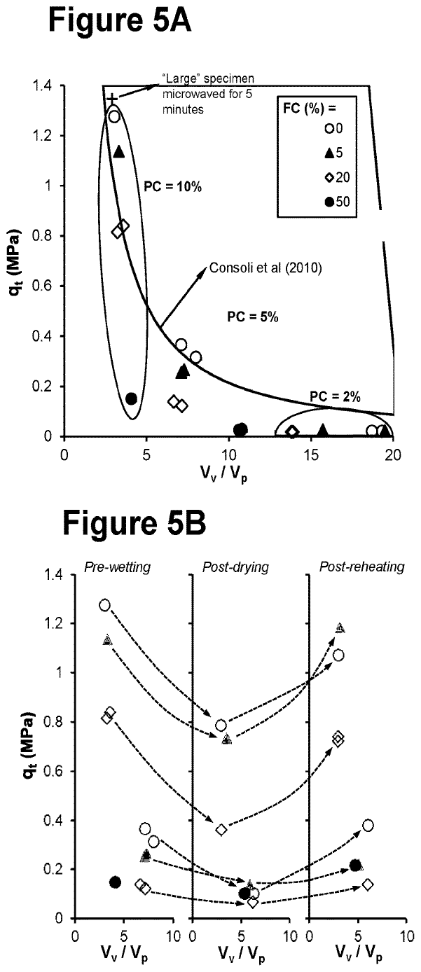

FIGS. 5A and 5B illustrate tensile strengths of specimens in accordance with an embodiment. FIG. 5A shows the tensile strength of unwetted specimens. The curve shown fits data for a Portland cemented sand where qₜ (MPa)=4.27 (Vᵥ/Vₚ). Specimens regain strength following re-exposure to microwaves after infiltration and drying as shown in FIG. 5B. The tensile strengths of un-wetted specimens are shown in FIG. 5A as a function of Vᵥ/Vₚ, where Vᵥ is the volume of voids and Vₚ is the volume of polymer. The additional curve shown fits data for Portland cemented sand where qₜ (MPa)=4.27 (Vᵥ/Vₚ). For each FC family, the strength varies with Vᵥ/Vₚ following a power-law trend for bonded aggregates. The strength is attributable to the amount of polymer available for bonding relative to the mineral surface area: Vᵥ/Vₚ (and PC) controls the former and FC controls the latter. Notably, a high FC, and thus a relatively high specific surface, leads to negligible strength even though the temperature attained increases with increasing FC (FIG. 3). For comparison, the qₜ values for specimens with Vᵥ/Vₚ<10 and FC≤5% are similar to those of sand-cement. Such trend is herein extended below (Vᵥ/Vₚ~8).

Infiltration and drying reduced qₜ by ~40±10%, as shown in FIG. 5B. Possible mechanisms include water absorption-induced stretching of molecular chains, resulting in scissions that cause a reduction in the polymer's strength, localized strains at mineral-polymer contacts due to absorption-induced polymer expansion, double layer repulsion forces, and the rise of capillary forces upon drying. Specimens regain strength following re-exposure to microwaves after infiltration and drying. Note in FIG. 5B that a significant proportion (at least about 85%) of the initial pre-wetting strength is regained by the subsequent dose of microwave heating. Indeed, re-melting re-anneals molecular chains, removing localized strains and creating free radicals to heal chain scissions. While molten, the polymer can also reincorporate at sites where the wet-dry cycle led to the rupture of polymer bridges. The ability to re-bond the degraded material via microwave re-exposure thus emerges as a salient attribute of the method.

Methods assisted by microwave heating to fabricate composites can be used for various applications including (but not limited to) (1) manufacturing of large construction bricks, and (2) in-situ treatment of polymer particle-laden rammed earth. The production of large bricks could be implemented via conveyors that transport the target masses through chambers equipped with microwave sources, where heating is fine-tuned via closed-loop controls. In the case of rammed earth, the microwave source would be placed on one side, say, of a rammed earth wall for a predetermined duration and then moved laterally and so forth to heat the entire wall in an overlapping pattern.

The microwave power penetration depth Sₚ, i.e., the distance at which the traveling wave power density reduces to 1/e of its incident value, can be relevant to the applications. Most common soils are not ferromagnetic or contain marginal amounts of magnetic components. In such cases, Sₚ is largely a function of the wavelength λ, the dielectric constant ε′, and the loss factor ε′ of the material, Sₚ=[λ(ε′)^{1/2}]/[2πε″]. For dry soils subject to 2.45 GHZ microwaves, ε″≈0.05 and ε′ varies between 1.5 and 4 (increasing as porosity decreases). These values yield 0.5 m<Sₚ<0.8 m. In turn, this suggests that substantially large bricks and rammed-earth walls (which have a typical thickness=0.3 m to 0.6 m) can be polymer-bonded via microwave heating. The absence of water is important. The relatively low boiling point of water and its relatively high microwave absorption rate (ε′≈75, ε″≈10 for 2.45 GHz microwaves) limits microwave-mediated polymer bonding to applications where the soil is dry. Therefore, in the case of wet-cast bricks and rammed earth walls, a low microwave power stage imposed to speed the drying process would precede a higher power stage imposed to produce the polymer bonding.

Heat transfer associated with a convection oven involves conduction of external heating from the surface of a soil mass into its interior, whereas microwave radiation enables internal heating of the mass as it absorbs microwaves. An experiment is conducted to explore the role of specimen size via a simple comparison, as follows. Two “large” specimens composed of sand with FC=0 and PC=10% are prepared like the previously described specimens, and with the same aspect ratio, but with diameter=11.6 cm (vs. 2.5 cm) and mass=1100 g (vs. 15 g). One is placed in a microwave oven and the other is placed in a convection oven preheated to 150 °C. Both are heated for 5 minutes (a duration that led to a temperature of 179 °C in the center of an equally sized microwaved polymer-less soil sample). When tested for its tensile strength, the large, microwaved specimen fractured diametrically like the smaller specimens. Inspection revealed hardened polymer-bonding throughout the entire fracture surface. Its tensile strength, plotted with a ‘+’ marker in FIG. 5A, is almost the same as that of the smaller equivalent specimens: microwave exposure rendered polymer bonding of the entire large, microwaved specimen in only 5 minutes. By contrast, the specimen placed in the convection oven did not exhibit any bonding after 5 minutes: it simply poured into a mound upon removal from the oven. Indeed, additional trials revealed that about 100 minutes would have been necessary to raise the temperature of the entire specimen to 150 °C in the convection oven; that is about 20 times longer than that required via microwaves. These complementary experiments confirm the benefits of internal heating for polymer bonding of soils, as provided by microwaves, particularly when the target soil mass is large and thus prohibits efficient bonding via external heating.

### Clay-Polymer Composites

Many embodiments provide clay-polymer composites that can be used as fired clay brick substitutes. Each specimen is manufactured by dry pressing a mixture of kaolinite clay and polyester particles and then heating the extruded green body. Heat is imposed to melt the polyester particles, such that a bonded composite (also referred as brick in the disclosure) upon cooling. Emphasis is tilted towards composites wherein the clay species predominates. The approach benefits from two points: added water is unnecessary and heating is imposed on mold-less bodies. Results indicate that green bodies preserve their shape after extrusion regardless of volumetric polymer content (PCᵥ). Similarly, bricks preserve their shape and largely their volume after heating. The p-wave modulus is higher for bricks than for green bodies, offering evidence that the fabric of the material is stiffened via polymer melting, coalescing, and cooling, despite the preservation of specimen shape and volume. The tensile strength of bricks rises with increasing PCᵥ and remains unaffected by water infiltration. In particular, the brick with PCᵥ=40% (with green body pressed to 22.5 MPa) have a lower water absorbability, a higher tensile strength, and a lower embodied energy associated with manufacturing than that of a standard fired clay brick, making the former a potential candidate for substitution of the latter in permissible applications.

Clay bricks may be one of the oldest building materials. Clay-based sun-dried brick preceded fired clay bricks. The latter were first developed around 3,000 BC and were heated to temperatures of about 1000 °C in kilns. “Firing” produces physical-chemical alterations that lead to improved strength. Coal replaced wood and straw for kiln fuel in the latter part of the 19th century. Brick manufacturing has undergone mechanization in the modern era. Technology has enabled a rate of production on the order of tens of thousands of pre-heated, i.e., green body, bricks per hour.

Polymeric materials have been used extensively in construction and civil engineering applications. These include polymeric sealants and coatings, bulk polymers for use in flooring, pipework, geosynthetics for retaining walls, embankments, landfill liners, polymer foams for insulation, and structural composites such as fiber reinforced polymers and polymer concrete. Polymers are also used in applications that extend beyond civil engineering.

Many embodiments provide composites comprising particles and polymers. The composites are also referred as particle-polymer composites. Conventionally, composites composed of a polymer matrix contain a discontinuous particulate phase, i.e., filled polymers. By contrast, many embodiments provide composites composed of a clay matrix that contains an initially discontinuous polymer phase (made of particles). The conventional type, i.e., filled polymers, can be categorized into two sub-types: immiscible composites, where particles are immiscibly dispersed in the polymer matrix and layered polymer nanocomposites where polymer chains are intercalated between the unit layers of layered silicates or where delaminated layers are dispersed in the polymer matrix. Immiscible polymers can be reinforced by synthetic materials such as chopped glass, carbon, aramid fibers, natural materials such as jute, hemp, and sisal fibers, and with hybrid mixtures of synthetic and natural fibers. Furthermore, such composites can be engineered with additives or modifying fillers, including pigments, antioxidants, and mineral particles, to name a few common modifiers.

Synthesis of layered polymer nanocomposites can be achieved by a variety of methods, many of which require first rendering the clay organic via substitution of the clay's structural ions by organic compounds. Montmorillonite, a 2:1 swelling clay, is commonly used for manufacturing layered polymer nanocomposites as it permits such substitution readily and more easily than kaolinite, a clay more resistant to intercalation given its 1:1 structure and low cation exchange.

Many embodiments provide fabrication methods of a non-intercalated clay-polymer composite with mechanical properties comparable to those of a standard fired clay brick. The dry-pressing method of manufacturing of fired clay bricks for construction applications involves compression of clay in a mold, extrusion of the compressed ‘green body’ from the mold, and heat-induced transformation of such body into a fired clay brick. The clay associated with dry-pressing for fired clay brick fabrication may have a gravimetric water content (w) of up to ~10%. The fabrication methods of the claim-polymer composite in accordance with many embodiments include the following advantages: (i) the clay is dry, i.e., w about 0, although containing hygroscopic water due to the non-zero humidity of the ambient air, (ii) the clay is mixed with polymer particles before the mixture is pressed, and (iii) the compressed body is heated after extrusion to a temperature (about 150 °C), only slightly higher than that required to melt the polymer particles (about 120 °C). The target temperature is well below that used to produce a fired clay brick. Cooling of the molten polymer renders a thermally bonded clay-polymer composite. Several embodiments fabricate composites with a variety of polymer contents. Some embodiments fabricate polymer-filled clays (i.e., low polymer content mixtures), whereby the clay matrix is reinforced by polymeric bonding, and thus a composite analogous to a fire brick is created.

Clay polymer composites in accordance with many embodiments implement: (i) dry clay, (ii) clay mixed with polymer particles before pressing, and (iii) the compressed body is heated to temperatures only high enough to melt the polymer particles (about 150 °C); i.e., the target temperature is thus well below the typical used to produce a fired clay brick. Upon cooling, the molten polymer renders a thermally bonded clay-polymer composite with competitive mechanical properties.

In several embodiments, the mineral species comprises almost entirely of fines, i.e., clay or particles that are smaller than the polymer particles. Given its pronounced specific surface, the strength and stiffness of the resulting composite is hypothesized to be controlled by the degree to which the molten polymer particles can coalesce to produce an internal polymeric network, alike an internal reinforcement skeleton, upon cooling. Some embodiments use clay-polymer composite specimens with varying polymer contents, and evaluate their water absorption and strength properties, to enable comparisons with common fired clay bricks used in construction applications.

For the heat-induced polymer bonding of sands, a low proportion of small polymer particles (with dₚ<d_{sand}) are initially dispersed in the pore space and the mixture is then heated and allowed to cool to render an artificial rock. The strength of the resulting composite is governed by the degree to which the molten polymer renders a network of sand grains that are bonded by polymer bridges. However, the results do not apply to the scenario where the polymer particles are larger than the mineral grains. In such a case, one would expect polymer particles to be dispersed inside the soil matrix (provided that polymer content is low). One would further expect the polymer particles to become molten plumes inside the mineral matrix upon heating and that interconnection of such plumes would occur via polymer wicking, provided that the initial proximity of the polymer particles is sufficiently small. This hypothesis is explored in the current article, as the mineral species used is comprised entirely of clay with d_{clay}<dₚ. Given the clay's relatively high specific surface, the strength and stiffness of low polymer content composites are hypothesized to be controlled by the degree to which the molten polymer particles, i.e., the plumes, can coalesce to produce a polymeric network within the clay matrix, alike an internal reinforcement skeleton, upon cooling. The objective of the current study was to manufacture a family of clay-polymer composite specimens with varying polymer contents and to evaluate their water absorption and strength properties with emphasis on their potential use in construction applications.

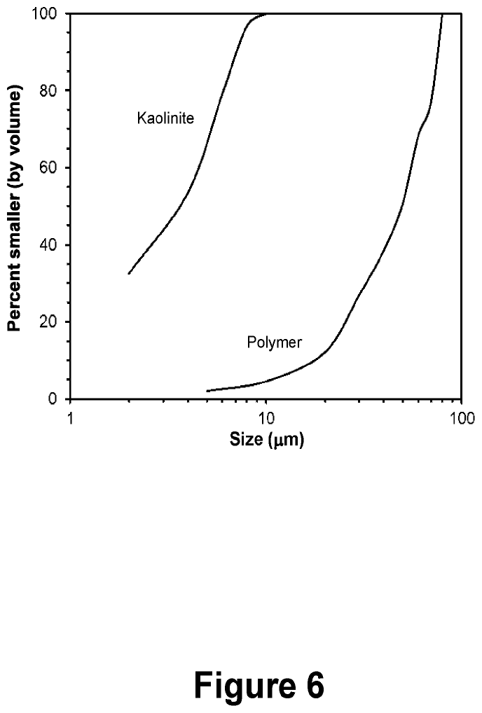

A powdered polymer composed of angular particles (Tiger Drylac 016/00030) employed for surface coating applications was used as the bonding agent. The SEM image of the polymer particles is shown in FIG. 1. The polymer has a solids density of about 1.2 μm/cm³, a tensile elastic modulus of about 460 MPa, and a tensile strength of about 17 MPa at a strain of about 5%. It initially softens at about 95 °C, it perceivably melts at about 120 °C, is thermally stable below about 285 °C, and is characterized as a polyester based on FTIR spectrometry. The polymer's thermogram and FTIR spectrum are shown in FIGS. 2A and 2B. FIG. 6 illustrates particle size distributions of the polymer and kaolinite particles in accordance with an embodiment. The particle size distribution can be obtained with a particle size analyzer. The size distribution shown in FIG. 6 indicates that dₚ is less than about 80 μm.

Grolleg kaolinite can be used as the clay species as it is a readily available clay known to be relatively free of impurities. In addition, kaolinite is a non-swelling clay, which is preferable to swelling clays (e.g., bentonite) for the fabrication of construction elements that would be subject to moisture. Each kaolinite particle is composed of a stack of unit layers held to each other by hydrogen bonds. Each layer is comprised of a tetrahedral silica sheet and an octahedral aluminum sheet; sheets are held together by shared oxygen atoms. The kaolinite used has a solids density of about 2.7 g/cm³ and is composed of particles with delay less than about 10 μm. The kaolinite particles are substantially smaller than the polymer particles, i.e., d_{clay}<dₚ, as shown in FIG. 6.

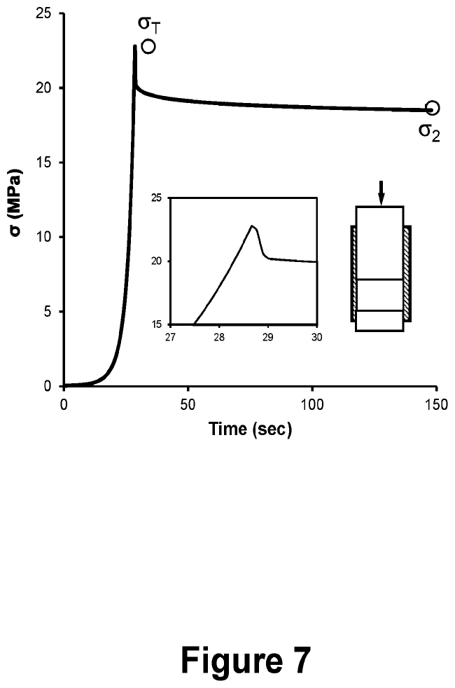

The brick fabrication process comprises three steps. First, predetermined masses of ambient-dry clay and polymer particles are placed in a closed vessel to achieve the desired volumetric polymer content,

$${PC}_{v} = \frac{{V}_{p}}{{V}_{p} + {V}_{c}}$$

where Vₚ is the volume of polymer particles and V_{c} is the volume of clay. The vessel is then shaken manually for a few minutes. Electrical attraction forces, which prevail over the weights of the clay and polymer particles, enable this method to produce a perceivably homogenous and unsegregated mixture. Second, the mixture is funneled into a steel die with diameter of about 29 mm and compressed with a piston at a rate of 0.5 mm/s to a target pressing stress or using a 100 kN capacity Instron load frame. A pressing stress σ_{T} of about 22.5 MPa is selected as it falls within the lower end of the range commonly used for dry-pressing clay bodies in the fabrication of fired clay bricks. Upon reaching σ_{T}, the frame displacement is halted for two minutes. The halt is implemented to minimize spring-back of the compressed mixture upon unloading and to observe the relaxation response of the compressed body, with emphasis placed on the polymer content. FIG. 7 illustrates a stress-time curve in accordance with an embodiment. In FIG. 7, compression and relaxation response of a PCᵥ=0.4 mixture pressed to σ_{T}=22.5 MPa. The term σ₂ denotes the stress reached after two minutes of relaxation. Insets show an enlarged view of the peak region and sketch of piston-die press. Third, the mixture is unloaded, and the resulting cylindrical green body is extruded from the die with the load frame by pushing a longer piston at a rate of about 2 mm/s. All green bodies exhibit a rotund cylindrical shape, i.e., geometric stability, after extrusion, including PCᵥ=0 (i.e., 100% clay) and PCᵥ=1 (i.e., 100% polymer) bodies.

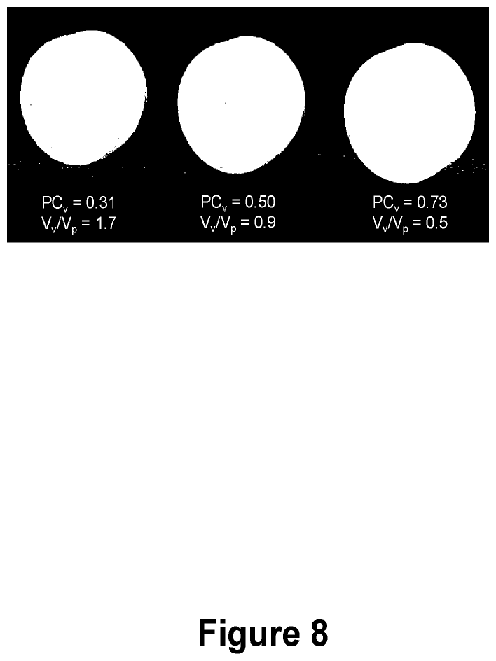

In some of the embodiments, the heating stage is implemented with a programmable furnace lined with alumina insulation. Green bodies are heated in groups of seven, from room temperature (~22 °C) to 150 °C at a rate of 4.2 °C/min, followed by a thermal soak at about 150 °C for 20 minutes. The green bodies are then allowed to cool back to room temperature inside the oven at a cooling rate of about 2 °C/min. Post-heating, the resulting bodies are termed ‘bricks’. All bricks retained a rotund cylindrical shape post-heating, except bricks with PCᵥ=1, which deformed by sagging and were thus disregarded. FIG. 8 illustrates pictures of the bricks in accordance with an embodiment. The nominal brick diameter shown in FIG. 8 is about 29 mm. The volume change due to heating is determined for all bricks, as a volumetric strain:

$${ϵ}_{vol} = \frac{{V}_{b} - {V}_{gb}}{{V}_{gb}}$$

where V_{b} is the volume of the brick and V_{gb} is the volume of the green body post extrusion.

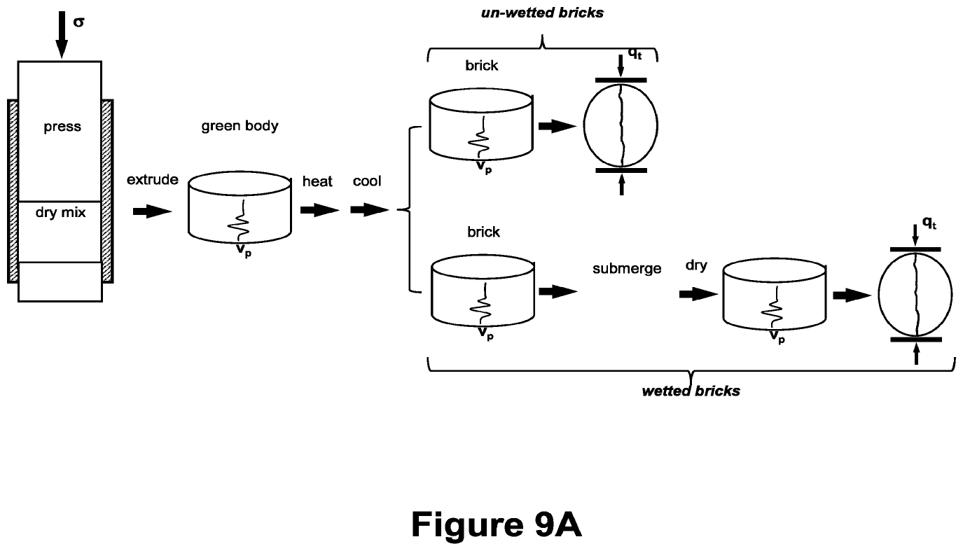

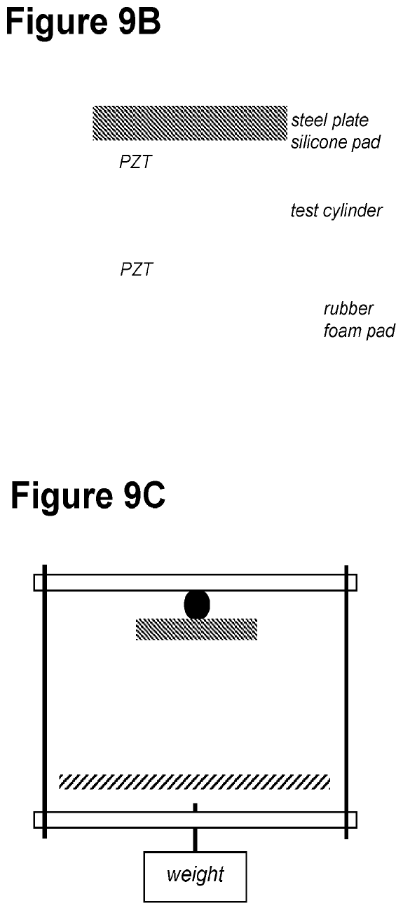

Three sets of measurements: water absorption, p-wave velocity, and tensile strength are performed on two groups of bricks. FIG. 9A illustrates a schematic of brick fabrication process and testing in accordance with an embodiment. In the first group, each brick is subject to a p-wave velocity (vₚ) measurement followed by a tensile strength (qₜ) test. The bricks in this first group are termed ‘unwetted bricks’. In the second group, each brick is (i) subject to a vₚ measurement, (ii) tested submersed in water absorption, (iii) subject to a second vₚ measurement after drying, and (iv) tested for qₜ. The bricks in the second group are termed ‘wetted bricks’.

The water absorption test is particularly relevant to the case of utilizing bricks for various applications. Bricks were weighed prior to submersion in de-ionized water for thirty days, immediately after removal from water, and after air drying at room temperature. Absorbability for each brick was quantified via the water content:

$$w = \frac{{M}_{w}}{{M}_{s}}$$

where M_{w} is the mass of water absorbed and Mₛ is the mass of solids, i.e., the mass of the dry brick.

The p-wave velocity measurement offers a non-destructive means to calculate the p-wave modulus:

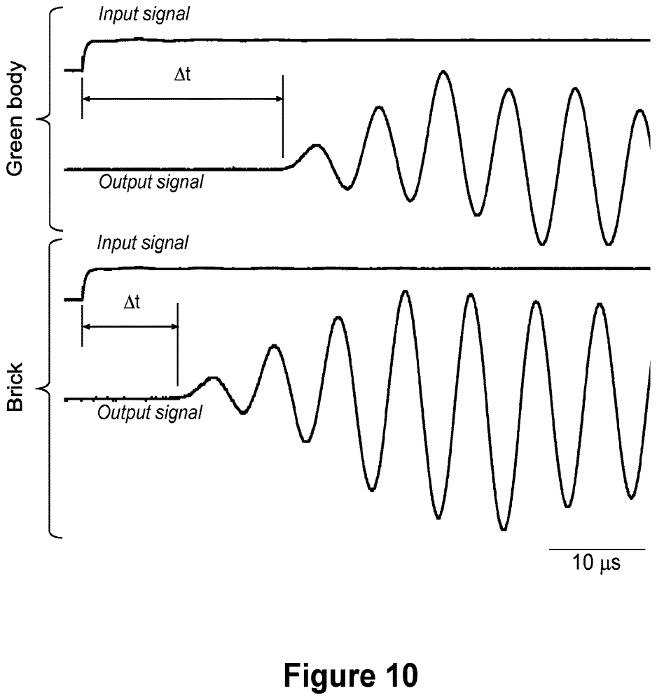

M=ρ(vₚ)³

where ρ is the bulk density of the material. Measurements are based on ASTM C597-16. Each test is conducted by sandwiching the test specimen, i.e., either a green body or a brick, between two piezo transducers (PZT). FIGS. 9A and 9B illustrate p-wave measurement setups in accordance with an embodiment. The test specimen rests between two PZTs as shown in FIG. 9A. A seating stress of about 30 kPa imposed with a weight and a hanger ensures quality contact between the PZTs and the specimen as shown in FIG. 9B. The bottom PZT lies on a 1 cm thick foamed rubber pad, and a 3 mm thick silicone pad lies above the top PZT. A small steel plate lies on the silicone pad, and a seating stress of about 30 kPa is imposed through a steel ball bearing that supports a hanger with weights. The seating stress improves coupling contact between the PZTs and the specimen and provides effective pulse transmission and wave reception. A 7-volt square wave with frequency=3 Hz is fed by a signal generator simultaneously to the bottom PZT and an oscilloscope. The response of the top PZT is fed through a 1 kHz high pass filter with 10 dB gain into the oscilloscope, which stacks the signals gathered. The wave travel time for all specimens is shorter than the square wave period. Therefore, the input signal is essentially a recurring pulse. FIG. 10 illustrates p-wave testing signal pairs in accordance with an embodiment. The p-wave testing signal pairs are scaled for a specimen with PCᵥ equals to about 0.5 before (top) and after (bottom) heating. The compression wave velocity for a given specimen is calculated as vₚ=H/Δt, where Δt is the measured travel time, and H is the distance between the PZTs, i.e., the thickness of the specimen.

Tensile strength characterization is selected to probe the bonding quality from which the strength of the material is derived. The Brazilian disc tension test (ABNT NBR 7222; ASTM D3967-16) is chosen to take advantage of the cylindrical shape and dimensions of the prepared bricks. Each brick is loaded diametrically up to failure, i.e., equatorial splitting, where the tensile strength (qₜ) is associated with the load at failure, and the diameter (D) and thickness (H) of the brick as:

$${q}_{t} = \frac{2 P}{π DH}$$

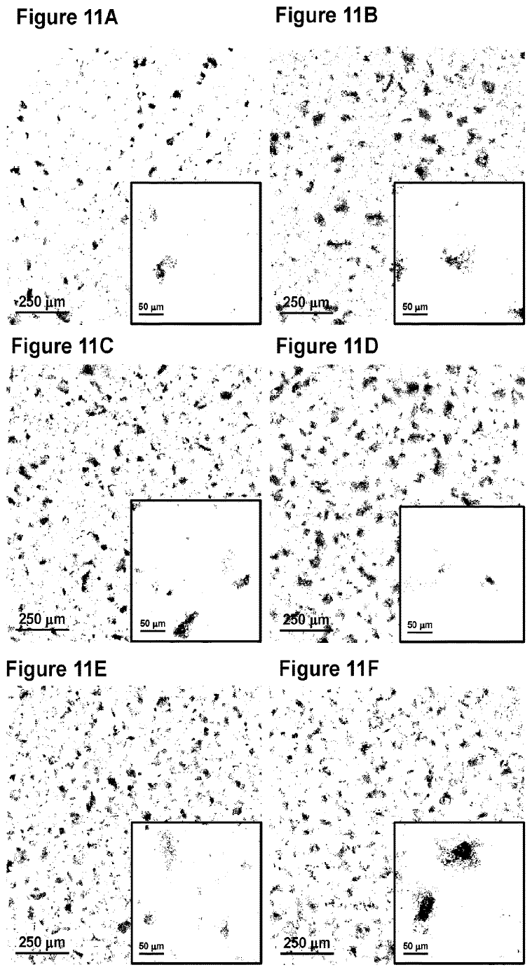

FIGS. 11A through 11F illustrate optical microscope images of selected specimens in accordance with an embodiment. FIGS. 11A, 11C and 11E are images of green bodies with PCᵥ=0.18, 0.40, and 0.73, respectively. FIGS. 11B, 11D, and 11F are images of bricks with PCᵥ=0.18, 0.40, and 0.73, respectively. The images are magnified by about 10 times and insets are magnified by about 500 times. The optical images offer qualitative insight into the differences between green bodies and bricks, and provide a visual framework to discuss experimental test results. Consider green bodies first (PCᵥ rises from FIGS. 11A, 11C, to 11E). Polymer particles, particularly large ones, are readily visible as dark zones embedded in the lighter kaolinite background. The rising concentration of polymer particles in the green bodies is readily visible as PCᵥ rises. In turn, their proximity rises with increasing PCᵥ, with large polymer particles reaching visually perceivable interconnectivity in the PCᵥ equals to about 0.73 green body. As for the bricks (PCᵥ rises from FIGS. 11B, 11D, to 11F), for each PCᵥ, the polymer appears as larger bodies on the brick than on the green body, indicating that the polymer can extend beyond its polymer particle footprint by wicking locally while molten through the clay. In turn, such extension increases polymer proximity and promotes the creation of polymer interconnectivity zones, provided that the polymer content is sufficiently high. Indeed, the effect of heating on improving heat-induced polymer interconnectivity for PCᵥ equals to about 0.18 (i.e., FIGS. 11A and 11B) appears to be marginal, whereas for PCᵥ equals to about 0.40 (i.e., FIGS. 11C and 11D), such effect is pronounced. For PCᵥ equals to about 0.73 (i.e., FIGS. 11E and 11 F), heating locks the already-interconnected polymer network present in the green body. Recall that these particle-scale transformations occur without any measurable alteration of the geometrical stability of the green bodies, which are heated mold-less in the furnace.

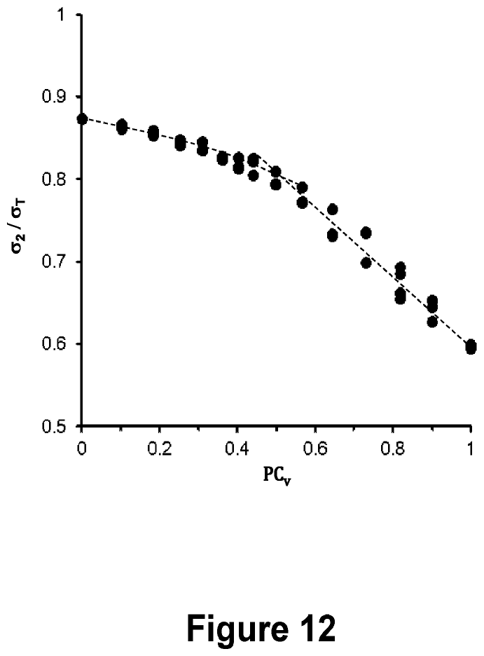

FIG. 12 illustrates a summary of the stress relaxation behavior associated with compression results in accordance with an embodiment. Dashed lines represent interpreted trends. In FIG. 12, the stress reached after two minutes of relaxation (62) is normalized by pressing stress σ_{T}. The manifestation of the stress relaxation response shown in FIG. 12 is consistent with experimental protocol and the time-dependent behavior of polymers. In the former, the piston displacement is halted once the target pressing stress is reached, effectively submitting the green body to a constant strain held for 2 min. As such, the imposed experimental condition activates the time-dependent properties of the mixture, i.e., the relaxation modulus, allowing the induced stresses to relax as time lapses. The stress relaxation decreases monotonically as a function of the polymer content, with an apodictic inflection point at PCᵥ about 0.5. This threshold PCᵥ is deemed fabric dependent, and therefore a function of the mixture's particle shapes and sizes. As PCᵥ increases, the viscoelastic properties of the polymer particles dominate the relaxation behavior, showing a significant stress reduction as a function of time.

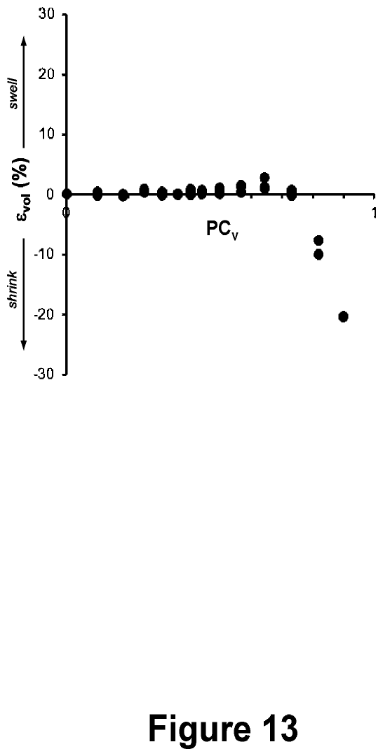

FIG. 13 illustrates heat-induced volumetric strain transition from green body to brick in accordance with an embodiment. The volumetric strain (Evol) associated with the heat-induced transition from green body to brick is shown. In contrast to fired clay bricks, which shrink in the range of ϵᵥₒₗ=5% to 10% after firing, most of the clay-polymer bricks prepared expanded, albeit slightly, i.e., less than 2%. Bricks with high polymer content, i.e., PCᵥ equals to about 0.82 and 0.9 shrank substantially (i.e., ϵᵥₒₗ>8%). A high PCᵥ translates to a significant loss of void volume as the predominant polymer particles melt and coalesce. Given their significant shrinkage, bricks with PCᵥ=0.82 and 0.9 are excluded from additional tests.

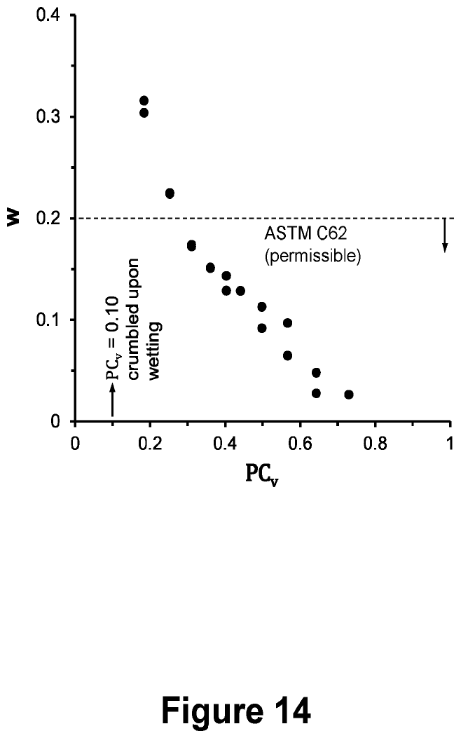

The response to water submersion is dependent on the polymer content. Bricks with PCᵥ≤0.10 crumbled upon wetting, whereas water absorption for bricks with PCᵥ≥0.18 decrease with increasing PCᵥ. FIG. 14 illustrates brick water absorption in accordance with an embodiment. FIG. 14 shows the water content vs the polymer content. The shown gravimetric water content attained by each submerged brick is calculated assuming that the polymer has the mass density of the clay solids (i.e., 2.7 g/cm³). Such calculation is needed to compare the water content with the maximum permissible water infiltration levels for fired clay bricks, which is w=0.2 for severe weather applications (ASTM C62; ABNT NBR 9778). The data indicates that bricks with PCᵥ≥0.25 meet this specification.

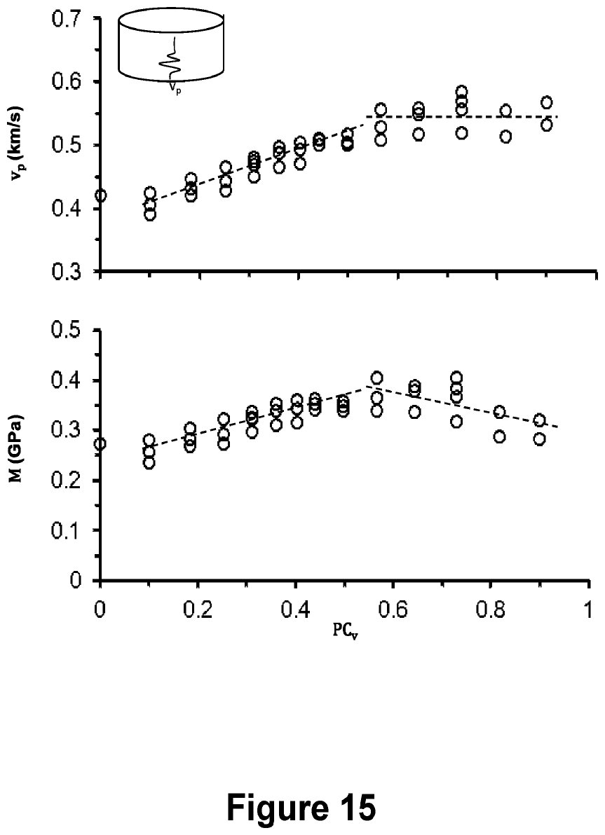

FIG. 15 illustrates the p-wave velocities and moduli of green bodies in accordance with an embodiment. Dashed lines represent interpreted trends. The PCᵥ-dependent green body velocity and modulus trends with duplicate and triplicate values, bear similarity to the relaxation results (shown in FIG. 12), in that a notable inflection point occurs around PCᵥ about 0.5, i.e., PCᵥ about 0.55 for vₚ and M trends. At low polymer contents the polymer particles are not interconnected (e.g., FIG. 11A) and therefore, the pressing stress is likely distributed primarily through the clay matrix, leading to its densification via forcing clay particles towards a face-to-face fabric. As the polymer content increases, the stress borne by the progressively smaller clay zones increases, thereby increasing clay densification; hence the rise in vₚ and M with increasing PCᵥ. Polymer particles interconnect at high polymer contents (e.g., FIG. 11C), and therefore take a substantial proportion of the applied stress, in doing so bearing sufficient load to deform, thus contributing additional densification. However, although an increase in the polymer content leads to a porosity reduction, it also leads to a bulk density (ρ) reduction, given that the solid density of the polymer is lower than that of the clay. This results in a modulus reduction per equation and occurs when PCᵥ is greater than about 0.55 for the green bodies.

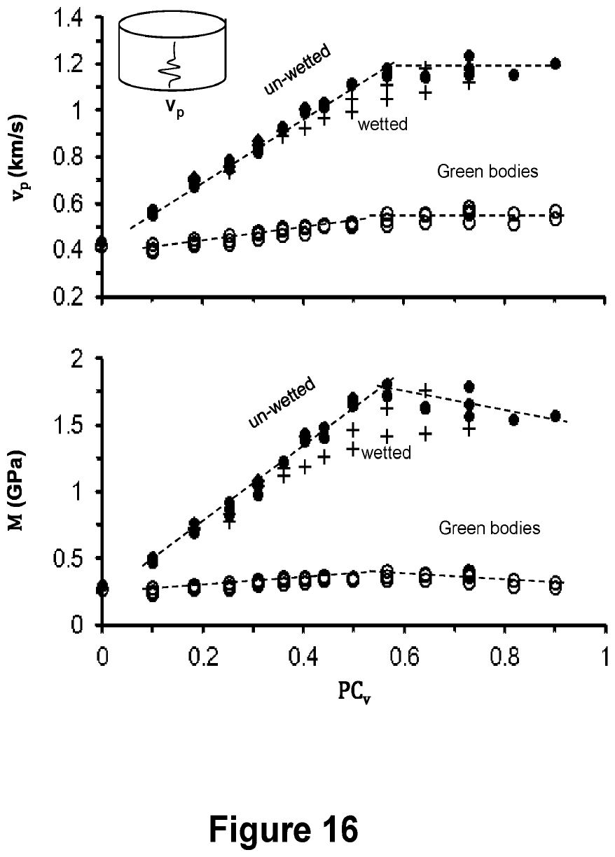

FIG. 16 illustrates the p-wave velocities and moduli of un-wetted and wetted bricks in accordance with an embodiment. Data for green bodies (shown in FIG. 15) are shown for comparison. Dashed lines represent interpreted trends. Bricks have larger vₚ and M when compared to green bodies (FIG. 16). This indicates that the material is stiffened substantially via polymer bonding. For green bodies, vₚ and M rise towards an inflection point around PCᵥ about 0.55. The data and images (FIGS. 11A through 11F) suggest that when PCᵥ is low, each molten polymer particle spreads locally (e.g., FIGS. 11A and 11B), promoting interconnectivity of clay particles bonded by polymer bridges. The degree with which the polymer itself interconnects while molten rises as PCᵥ rises towards the PCᵥ about 0.55 inflection (e.g., FIGS. 11C and 11D), which marks a threshold above which an internal polymer network is fully established (e.g., FIGS. 11E and 11F). This continuous polymeric network controls the stiffness of the composite (FIG. 16).

The vₚ and M trends for wetted bricks, denoted by ‘+’ markers in FIG. 16, are generally similar to that measured for un-wetted bricks. There is, however, a notable difference for bricks with PCᵥ greater than about 0.5, whereby vₚ and M values for wetted bricks are slightly lower than those for un-wetted bricks. These differences can be attributed to the swelling of the polymer scaffolding during submersion due to the retention of water molecules within the structure, i.e., volumetric strains. In addition, dehydration relieves stress and causes internal damage in the form of chain scissions at the molecular scale and cracks at the micro-scale. Such micro-cracks are formed by a hydrostatic state of stress that, in this case, appears to overcome the bonding within the polymer network. The hygrothermal stability of polymers hinges on the reactions between free radicals (possibly created from the chain scissions) and the reactive oxygen species in the water.

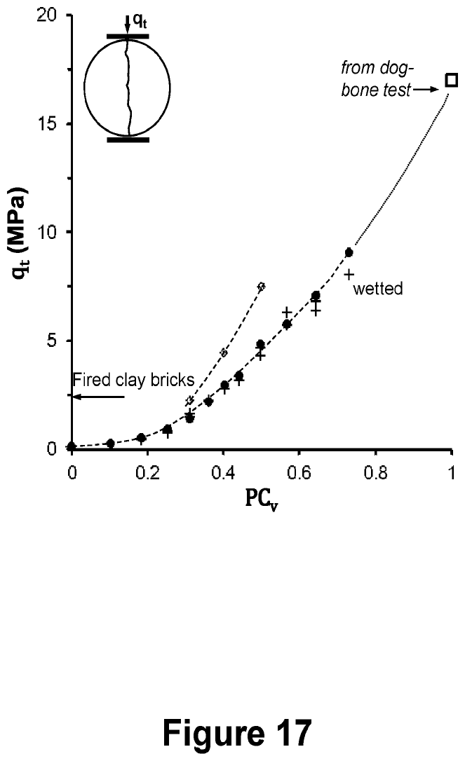

FIG. 17 illustrates tensile strength vs. polymer content for un-wetted and wetted bricks in accordance with an embodiment. The un-wetted and wetted bricks have σ_{T} of about 22.5 MPa. The square marker denotes the tensile strength of a cast polymer dog-bone specimen. Diamond markers denote the strengths of bricks with or of about 45 MPa. FIG. 17 shows that the tensile strength of bricks rises with increasing PCᵥ and in agreement with the images presented in FIGS. 11A through 11F. The rise in strength with increasing PCᵥ, despite the inflection point observed for vₚ and M data when PCᵥ of about 0.55 (FIG. 16), suggests that for bricks with PCᵥ less than about 0.55, the strength is proportional to the extent of polymer proximity and interconnectedness; whereas for bricks with PCᵥ greater than about 0.55, the strength is likely derived from the quality of the polymer skeleton, i.e., the thickness and number of its strands. The strength of the composite is also dependent on the clay-polymer bonding resistance, which likely involves a combination of interactions, such as increased van der Waals attraction due to a reduced distance of separation while the polymer is molten, improved mechanical interlocking caused by molten polymer penetration through clay particle clusters, and hydrogen bonding of the hydroxyl groups on the kaolinite particles with hydroxyl or carbonyl groups present in the polymer.

Slight strength differences are observed for wetted bricks with PCᵥ equals to about 0.64 and 0.73 (vs. analogous un-wetted bricks), whereas not for bricks with lower polymer contents. As expected, small-strain properties (vₚ and M, FIG. 16) exhibit a higher sensitivity to material variations compared to large-strain properties (qₜ, FIG. 17).

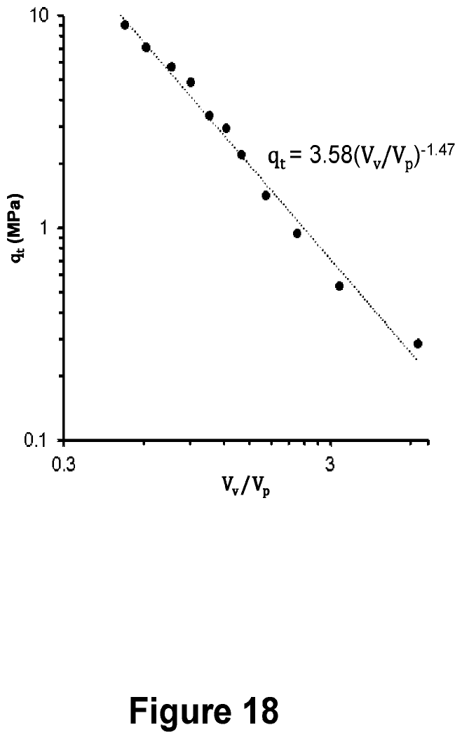

In particular, the tensile strength of bricks with PCᵥ equals to about 0.4 (pressed to σ_{T}=22.5 MPa) is considerably greater than that reported for unmodified fired clay bricks, i.e., 2.9 MPa vs. 1 MPa to 2.5 MPa (FIG. 17). This combination thus renders thermally bonded clay-polymer bricks a potential substitute for unmodified fired clay bricks in permissible applications. A power-law trend may emerge when the strength of soils bonded with Portland cement is plotted vs. the porosity-binder ratio, (Vᵥ/V_{bin}); herein V_{bin}=Vₚ and Vᵥ is the volume of voids. FIG. 18 illustrates a power law relationship between the tensile strength and porosity-binder ratio for bricks in accordance with an embodiment. The fit has R² of about 0.99. Tensile strengths indicate that a power-law trend is also evident for thermally bonded clay-polymer bricks. In general, the tensile strength of the clay-polymer bricks fabricated in the current study (fit exponent=−1.47; FIG. 18) is more sensitive to the porosity-binder ratio than sand-cement (fit exponent=−1.3).

The substitution of materials with those that have lower energy production costs is a potential approach to the reduction of energy demands. For comparison, the PCᵥ=0.4 brick, chosen as it is less water-absorbent and stronger (i.e., by a factor of about 1.2 to 2.9, FIG. 17) than a fired clay brick. One could reasonably assume that both brick types share the same energy expenditures associated with sourcing and handling of the clay, including pressing, which for clay-polymer mixtures with PCᵥ=0.4 pressed to σ_{T}=22.5 MPa, is about 3 MJ/m³. Added water is not necessary to manufacture the clay-polymer bricks, whereas it is necessary for manufacturing fired clay bricks, giving an advantage point to the former.

Powdered polymer is an important component of clay-polymer bricks, whereas it is not for fired clay bricks. The polymer used was purchased from a manufacturer; yet one would expect similar mechanical performance, yet lower embodied energy if atomized recycled plastics are used instead. The energy associated with fine comminution of recycled plastics is about 700 kWh/Mg; which translates to 3 GJ/m³, calculated with the used polymer's density (i.e. ρₚ=1.2 μm/cm³). Thus, the energy associated with plastic grinding for production of a PCᵥ=0.4 brick is estimated as (0.4×3 GJ/m³)=1.2 GJ/m³.

Fired clay bricks require heating to approximately six times the temperature required for treatment of clay-polymer bricks. The heating energy associated with a change in temperature from T₂ to T₁ is:

E=ΔTρc

where c is the specific heat capacity, and T=T₂−T₁. The specific heat capacity of the mixture can be approximated as a weighted average of the specific gravity of kaolinite, i.e., cₖ≈945 J/kg °C and that of the polyester, i.e., cₚ≈1000 J/kg °C, as

c=cₚ(PCᵥ)+cₖ(1−PCᵥ)

Using the measured density of PCᵥ=0.4 bricks, i.e., ρ=1.41 g/cm³, and c≈970 J/kg °C yields 0.16 GJ/m³ for T=T₂−T₁=150 °C−20 °C=130 °C. By contrast, 1570 kg/m³. 1000 J/(kg °C)·(1200 °C−20 °C)≈1.8 GJ/m³ for fired clay bricks. Heating of clay-polymer bricks requires only about 10% of the energy associated with the heating of fired clay bricks. A lower temperature target, i.e., 150 °C vs. 1200 °C, and the fact that the polymer remains viscous at initial cooling stages, translates to a reduction in the time required for heating and cooling, and thus additional cost savings associated with production speed.

In some embodiments, the energy required to manufacture clay polymer bricks is about 85% of that required to manufacture clay-polymer bricks: 1.36 GJ/m³ vs. 1.48 GJ/m³, whereby most of the embodied energy is associated with grinding the plastic into a powder. This comparison excludes the cost of plastic (assuming that it is inexpensive or recycled) and the costs associated with mining and handling of the clay material (as it assumes that it is the same for both brick types). Finally, the comparison excludes added costs associated with the relatively longer heating and cooling times and the water needed for the fired clay brick fabrication.

The embodied energy associated with pressing (~3 MJ/m³) is negligible compared to that of plastic grinding (1.2 GJ/m³), and that the proximity of the polymer particles in a green body dictates the potential for the polymer to interconnect while molten. It seems reasonable to assume that such proximity is dependent on the stress to which the green body is pressed. Increasing the pressing stress may raise the brick strength to accommodate a polymer content reduction. The three mixtures, i.e., PCᵥ=0.31, 0.40, and 0.50, pressed to σ_{T}=45 MPa (vs. 22.5 MPa) as shown in FIG. 17 with diamond markers, confirms that qₜ is proportional to σ_{T} (for the mixture types tested). Therefore, the embodied energy could be reduced by lowering the polymer content and increasing the pressing stress. In addition, fired clay brick manufacturers could use the waste heat emitted by their firing kilns to fabricate clay-polymer bricks and run the production of both brick types in parallel.

Several embodiments provide bonded soil-polymer composite created by heating and cooling dry-pressed, mold-less mixtures of kaolinite clay and polyester particles (with dₚ>d_{clay}). Cylindrical specimens can be prepared for compression wave velocity, water absorption, and tensile strength testing. Extruded, unheated green bodies with a variety of polymer contents, ranging from PCᵥ=0 (clay only) to PCᵥ=1 (polymer only), exhibit geometrical stability upon extrusion, despite the absence of added water, which is unnecessary for the fabrication of the composites. In some embodiments, heating melts the polymer particles. The molten polymer wicks within the green body and hardens upon cooling, rendering a bonded composite. The proximity of the polymer particles in a green body dictates the extent to which the polymer can interconnect while molten and depends on the green body's polymer content and on the stress with which the green body is dry-pressed. The composite's tensile strength in accordance with certain embodiments is proportional to the polymer content, approaching the bulk polymer strength as PCᵥ tends to unity. The wave speed, however, plateaus at a threshold polymer content due to constraints set by the material's fabric and density, in turn influenced by the pressing stress and particle sizes.

Clay-polymer composites offer the possibility of replacement of unmodified fired clay brick (and likely other construction materials). The fabrication needs no added water, and green bodies can be heated mold-less. The production time is an order of magnitude lower. Composites with PCᵥ=0.4 pressed to σ_{T}=22.5 MPa feature a lower water absorption and a higher strength. The total embodied energy is 15% lower, assuming that the polymer is to be ground into fine particles. A lower embodied energy may be attained if atomization (vs. comminution) is implemented to powderize the polymer, and if a lower polymer content is reduced provided that the pressing stress is raised.

### 3D Printed Clay-Polymer Composites

Many embodiments implement 3D printing processes to make the clay-polymer composites. Several embodiments 3D-print composites made of kaolinite clay with added polymer particles. Some embodiments 3D-print two types of composites: un-foamed composites and foamed composites.

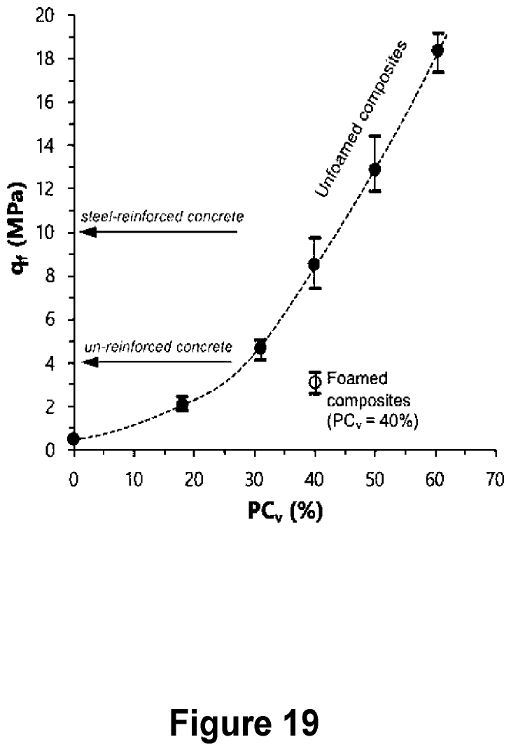

Un-foamed composites can be created by mixing the polymer and the clay to various volumetric polymer contents, i.e., PCᵥ=volume of polymer/(volume of polymer+volume of dry clay), and with water such that the mixture water content is w=mass of water/(mass of polymer+mass of dry clay) of about 48%. The components can be mixed into a paste, and then 3D printed. The paste can be extruded into cylindrical bodies. This can be achieved with a circular-tip extruder. A subset of such bodies can be heated to about 150 °C for about 20 minutes and then cooled. This heating processes can produce negligible (not observable by the naked eye) alterations of the shape of the bodies, and melt the polymer particles, which in turn renders each body a polymer-bonded composite upon cooling. Some embodiments test dry unheated bodies and heated bodies, each in 3-point flexural bending. FIG. 19 illustrates tensile strengths of the 3D printed clay-polymer composites in accordance with an embodiment. FIG. 19 shows that the unheated bodies have a low flexural strength, i.e., q_{f}≈0.5 MPa, as is expected for dry clay (this is why dry printed clay cannot be used to fabricate load-bearing structural elements). By contrast, the heated bodies have a higher flexural strength, and such strength rises with increasing polymer content. The attained flexural strength is in the range from about 2 to 18 MPa. In contrast, unreinforced concrete has a flexural strength of about 4 MPa, and steel-reinforced concrete has a flexural strength of about 10 MPa. Additional tests are performed with another clay (common, red terra-cotta clay), with PCᵥ about 40%, producing similar results as those attained for polymer-bonded kaolinite bodies with PCᵥ about 40%, i.e., q_{f}≈8.5 MPa.

Foamed composites can be created by dry mixing kaolinite clay and polymer particles components to PCᵥ about 40% (this polymer content is selected based on the flexural strength of the un-foamed composites). The mixture can be combined with an aqueous solution that contains a foaming agent, such that the solution content is wₛₒₗ=mass of solution/(mass of polymer+mass of dry clay) of about 60%. The components can be mixed into a paste and 3D printed. The extruded bodies can be dried at ambient temperature. The drying process causes precipitation of the foaming agent particles within the body. Certain embodiments heat the bodies to about 150 °C for about 20 minutes and let them cool. The heating processes can cause the bodies to nearly double in volume. The reason is that the foaming agent particles within the body degrade at around 100 °C and in doing so produce micro bubbles of CO₂. Such bubbles lead to foaming, i.e., expansion, of the structure, which is ultimately bonded by the melting and subsequent cooling of the added polymer particles. The result is a highly porous, low density, bonded composite. This is beneficial for lowering material cost and handling, as well as lower weight and better insulation performance. FIG. 19 shows the test of such bodies in 3-point flexural bending. As expected, the flexural strength of the foamed composites is lower than that of the un-foamed ones (given the more porous structure of the former). However, flexural strength is close to that of unreinforced concrete.

### EXAMPLES

Example 1: A method for fabricating soil composite, comprising: heating a mixture of materials using a microwave source, wherein the mixture of materials comprises a plurality of soil particles and a plurality of polymer particles.
Example 2: The method of example 1, wherein the plurality of soil particles comprises at least one material selected from the group consisting of: sand, slit, clay, rammed earth, gravel rock, desert sand, beach sand, white sand, river sand, manufactured sand, and granular ceramic.
Example 3: The method of example 1 or 2, wherein the plurality of soil particles comprises at least one microwave susceptor selected from the group consisting of: a natural conductive grain in sand, a ferric material, iron oxide, Fe₂O₃, carbon black, charcoal, graphite, silicon carbide, magnetite, and Fe₃O₄.
Example 4: The method of example 1, or 2, or 3, wherein the plurality of polymer particles comprises a thermoplastic polymer or a thermoset polymer.
Example 5: The method of any one of examples 1 to 4, further comprising molding the mixture before heating.
Example 6: The method of any one of examples 1 to 5, wherein the molding is achieved via using a mold or 3D printing.
Example 7: The method of any one of examples 1 to 6, wherein the mold has a shape selected from the group consisting of: a cylinder, a tube, a sphere, a hemi-sphere, an ellipse, a polygon, a cuboid, a cube, and a combination thereof.
Example 8: The method of any one of examples 1 to 7, wherein the microwave source creates a heating temperature less than or equal to 350 °C.
Example 9: A method for fabricating soil composite, comprising: molding a mixture material, wherein the mixture material comprises a plurality of soil particles and a plurality of polymer particles; wherein greater than 50% (v/v %) of the plurality of soil particles has an average diameter of less than or equal to 100 microns, and less than 50% (v/v %) of the plurality of soil particles has an average diameter of greater 100 microns.
Example 10: The method of example 9, further comprising heating the molded mixture material using a heat source selected from the group consisting of: a microwave source, an external heating source, and a convention oven.
Example 11: The method of example 9 or 10, wherein the plurality of soil particles further comprises at least one material selected from the group consisting of: sand, slit, clay, rammed earth, gravel rock, desert sand, beach sand, white sand, river sand, manufactured sand, and granular ceramic.
Example 12: The method of example 9, or 10, or 11, wherein the plurality of soil particles further comprises at least one microwave susceptor selected from the group consisting of: a natural conductive grain in sand, a ferric material, iron oxide, Fe₂O₃, carbon black, charcoal, graphite, silicon carbide, magnetite, and Fe₃O₄.
Example 13: The method of any one of examples 9 to 12, wherein the plurality of polymer particles comprises a thermoplastic polymer or a thermoset polymer.
Example 14: The method of any one of examples 9 to 13, wherein the microwave source creates a heating temperature less than or equal to 350 °C.
Example 15: The method of any one of examples 9 to 14, wherein the molding is formed via a process of using a mold or 3D printing.
Example 16: The method of any one of examples 9 to 15, wherein the mold has a shape selected from the group consisting of: a cylinder, a tube, a sphere, a hemi-sphere, an ellipse, a polygon, a cuboid, a cube, and a combination thereof.
Example 17: A soil composite, comprising: a plurality of soil particles and a plurality of polymer particles fused together using a microwave source, wherein the microwave source melts the plurality of polymer particles and binds the plurality of soil particles together.
Example 18: The soil composite of example 17, wherein the plurality of soil particles comprises at least one material selected from the group consisting of: sand, slit, clay, rammed earth, gravel rock, desert sand, beach sand, white sand, river sand, manufactured sand, and granular ceramic.
Example 19: The soil composite of example 17 or 18, wherein the plurality of soil particles comprises at least one microwave susceptor selected from the group consisting of: a natural conductive grain in sand, a ferric material, iron oxide, Fe₂O₃, carbon black, charcoal, graphite, silicon carbide, magnetite, and Fe₃O₄.
Example 20: The soil composite of example 17, or 18, or 19, wherein the plurality of polymer particles comprises a thermoplastic polymer or a thermoset polymer.
Example 21: The method of any one of examples 17 to 20, wherein the microwave source creates a heating temperature less than or equal to 350 °C.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the,” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A method for fabricating soil composite, comprising:
heating a mixture of materials using a microwave source, wherein the mixture of materials comprises a plurality of soil particles and a plurality of polymer particles.

2. The method of claim 1, wherein the plurality of soil particles comprises at least one material selected from the group consisting of: sand, slit, clay, rammed earth, gravel rock, desert sand, beach sand, white sand, river sand, manufactured sand, and granular ceramic.

3. The method of claim 1, wherein the plurality of soil particles comprises at least one microwave susceptor selected from the group consisting of: a natural conductive grain in sand, a ferric material, iron oxide, Fe₂O₃, carbon black, charcoal, graphite, silicon carbide, magnetite, and Fe₃O₄.

4. The method of claim 1, wherein the plurality of polymer particles comprises a thermoplastic polymer or a thermoset polymer.

5. The method of claim 1, further comprising molding the mixture before heating.

6. The method of claim 5, wherein the molding is achieved via using a mold or 3D printing.

7. The method of claim 6, wherein the mold has a shape selected from the group consisting of: a cylinder, a tube, a sphere, a hemi-sphere, an ellipse, a polygon, a cuboid, a cube, and a combination thereof.

8. The method of claim 1, wherein the microwave source creates a heating temperature less than or equal to 350 °C.

9. A method for fabricating soil composite, comprising,
molding a mixture material, wherein the mixture material comprises a plurality of soil particles and a plurality of polymer particles; wherein greater than 50% (v/V %) of the plurality of soil particles has an average diameter of less than or equal to 100 microns, and less than 50% (v/v %) of the plurality of soil particles has an average diameter of greater 100 microns.

10. The method of claim 9, further comprising heating the molded mixture material using a heat source selected from the group consisting of: a microwave source, an external heating source, and a convention oven.

11. The method of claim 9, wherein the plurality of soil particles further comprises at least one material selected from the group consisting of: sand, slit, clay, rammed earth, gravel rock, desert sand, beach sand, white sand, river sand, manufactured sand, and granular ceramic.

12. The method of claim 9, wherein the plurality of soil particles further comprises at least one microwave susceptor selected from the group consisting of: a natural conductive grain in sand, a ferric material, iron oxide, Fe₂O₃, carbon black, charcoal, graphite, silicon carbide, magnetite, and Fe₃O₄.

13. The method of claim 9, wherein the plurality of polymer particles comprises a thermoplastic polymer or a thermoset polymer.

14. The method of claim 10, wherein the microwave source creates a heating temperature less than or equal to 350 °C.

15. The method of claim 9, wherein the molding is formed via a process of using a mold or 3D printing.

16. The method of claim 15, wherein the mold has a shape selected from the group consisting of: a cylinder, a tube, a sphere, a hemi-sphere, an ellipse, a polygon, a cuboid, a cube, and a combination thereof.

17. A soil composite, comprising:
a plurality of soil particles and a plurality of polymer particles fused together using a microwave source, wherein the microwave source melts the plurality of polymer particles and binds the plurality of soil particles together.

18. The soil composite of claim 17, wherein the plurality of soil particles comprises at least one material selected from the group consisting of: sand, slit, clay, rammed earth, gravel rock, desert sand, beach sand, white sand, river sand, manufactured sand, and granular ceramic.

19. The soil composite of claim 17, wherein the plurality of soil particles comprises at least one microwave susceptor selected from the group consisting of: a natural conductive grain in sand, a ferric material, iron oxide, Fe₂O₃, carbon black, charcoal, graphite, silicon carbide, magnetite, and Fe₃O₄.

20. The soil composite of claim 17, wherein the plurality of polymer particles comprises a thermoplastic polymer or a thermoset polymer.

21. The soil composite of claim 17, wherein the microwave source creates a heating temperature less than or equal to 350 °C.
